(19) United States
(12) Patent Application Publication
(10) Pub. No.: US 2024/0353124 A1
(43) Pub. Date: Oct. 24, 2024

(54) SPRAY FAN

(71) Applicant: Nanjing Chervon Industry Co., Ltd., Nanjing (CN)

(72) Inventors: Pengpeng Cao, Nanjing (CN); Jianxun Dong, Nanjing (CN); Zhijun Chen, Nanjing (CN)

(21) Appl. No.: 18/594,213

(22) Filed: Mar. 4, 2024

(30) Foreign Application Priority Data
Apr. 20, 2023 (CN) 202310429885.6

(51) Int. Cl. F24F 5/00; F24F 6/14

(52) U.S. Cl. CPC F24F 5/0035; F24F 6/14

(57) ABSTRACT

A spray fan includes a fan assembly including multiple fan blades; an electric motor for driving the fan blades to rotate; a spray head assembly configured to spray a liquid; a water pump configured to deliver the liquid; and an adjustment device configured to adjust a flowrate of the liquid and including a channel for the liquid to flow through, where a flowrate of the liquid flowing through the channel decreases and then increases.

### RELATED APPLICATION INFORMATION

This application claims the benefit under 35 U.S.C. § 119(a) of Chinese Patent Application No. 202310429885.6, filed on Apr. 20, 2023, which application is incorporated herein by reference in its entirety.

### BACKGROUND

For a cooling purpose in hot weather, spray fans are often used to send out water mist through a wind to achieve a cooling effect. A spray fan has a nozzle and a water inlet pipe, where the water inlet pipe has an end connected to the nozzle and is connected to a water source through a distribution pipe, and the other end of the water inlet pipe is connected to a water pump that pumps the water source to the nozzle. The water source of the spray fan includes static water (such as a bucket) and dynamic water (such as tap water). The dynamic water source has a high water pressure, which may shorten a lifetime of the water pump.

### SUMMARY

A spray fan includes: a fan assembly including multiple fan blades; an electric motor for driving the fan blades to rotate; a spray head assembly configured to spray a liquid; and a water pump configured to deliver the liquid. The spray fan further includes an adjustment device configured to adjust a flowrate of the liquid and including a channel for the liquid to flow through, where a flowrate of the liquid flowing through the channel decreases and then increases.

In some examples, the channel is provided with an adjustment hole whose cross-section changes such that the flowrate of the liquid flowing through the channel decreases and then increases.

In some examples, the diameter of the adjustment hole is greater than or equal to 0.1 mm and less than or equal to 6 mm.

In some examples, the spray head assembly includes at least one jet, and the ratio of the area of the cross-section of the adjustment hole to a total area of a cross-section of the at least one jet is greater than 1 and less than or equal to 45.

In some examples, a flowrate of the liquid flowing through the adjustment hole is greater than or equal to 3 L/min and less than or equal to 30 L/min.

In some examples, two adjustment holes are provided, and the liquid in the channel flows through the two adjustment holes in sequence.

In some examples, the flowrate of the liquid flowing through the channel decreases and then increases for the second time.

In some examples, the liquid flowing through the channel has a first flowrate, a second flowrate, and a third flowrate, where the first flowrate is greater than or equal to 20 L/min and less than or equal to 22 L/min, the second flowrate is greater than or equal to 0.9 L/min and less than or equal to 1.4 L/min, and the third flowrate is greater than or equal to 0.6 L/min and less than 0.9 L/min.

In some examples, the liquid flowing through the channel has a first flowrate, a second flowrate, and a third flowrate, where the ratio of the first flowrate to the second flowrate is greater than or equal to 14:1 and less than or equal to 30:1, and the ratio of the second flowrate to the third flowrate is greater than 1:1 and less than or equal to 7:3.

In some examples, the spray fan includes a water inlet pipe, the adjustment device includes a first connector and a second connector, the first connector is connected to a water distribution pipe, the second connector is connected to the water inlet pipe, the first connector and the second connector are detachably connected, and the first connector and/or the second connector are provided with the adjustment hole.

In some examples, water pressure at the output of the water pump is less than or equal to 1.2 Mpa.

In some examples, the spray fan includes a water inlet pipe with an end connected to a dynamic water source or a static water source and the other end connected to the water pump, the adjustment device is disposed at an end of the water inlet pipe facing away from the water pump, and the liquid flows from the dynamic water source or the static water source to the water pump through the water inlet pipe and then is sprayed out from the spray head assembly.

The ratio of the length to the diameter of the adjustment hole is less than or equal to 0.5.

In some examples, the adjustment hole includes a straight portion and a funnel-shaped guide portion, and the guide portion is located at an upstream position of the adjustment hole relative to the straight portion.

In some examples, a relief valve disposed upstream of the water pump is further included.

A spray fan includes: a fan assembly including multiple fan blades; an electric motor for driving the fan blades to rotate; a spray head assembly configured to spray a liquid; and a water pump configured to deliver the liquid. The spray fan further includes an adjustment device configured to adjust a flowrate of the liquid and including a channel for the liquid to flow through, where pressure of the liquid flowing through the channel decreases and then increases.

In some examples, the channel is provided with an adjustment hole whose cross-section changes such that the pressure of the liquid flowing through the channel decreases and then increases.

A spray fan includes: a fan assembly including multiple fan blades; an electric motor for driving the fan blades to rotate; a spray head assembly configured to spray a liquid; and a water pump configured to deliver the liquid. The spray fan further includes an adjustment device configured to adjust a flowrate of the liquid and including a channel for the liquid to flow through, where the liquid flowing through the channel has a first flowrate and a second flowrate, and the ratio of the first flowrate to the second flowrate is greater than or equal to 14:1 and less than or equal to 30:1.

### BRIEF DESCRIPTION OF DRAWINGS

FIG. 1 is a structural view of a spray fan according to the present application.

FIG. 2 is a first structural view of a first connector, a second connector, and a water pipe connector involved in the present application.

FIG. 3 is a structural view of the first connector involved in FIG. 2.

FIG. 4 is a second structural view of a first connector, a second connector, and a water pipe connector involved in the present application.

FIG. 5 is a structural view of the first connector involved in FIG. 4.

FIG. 6 is a structural view of a second connector involved in the present application.

FIG. 7 is a structural view of a static water pipe connector involved in the present application.

FIG. 8 is a structural view of a dynamic water pipe connector involved in the present application.

FIG. 9 is an exploded view of a relief valve involved in the present application.

FIG. 10 is a sectional view of a relief valve involved in the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

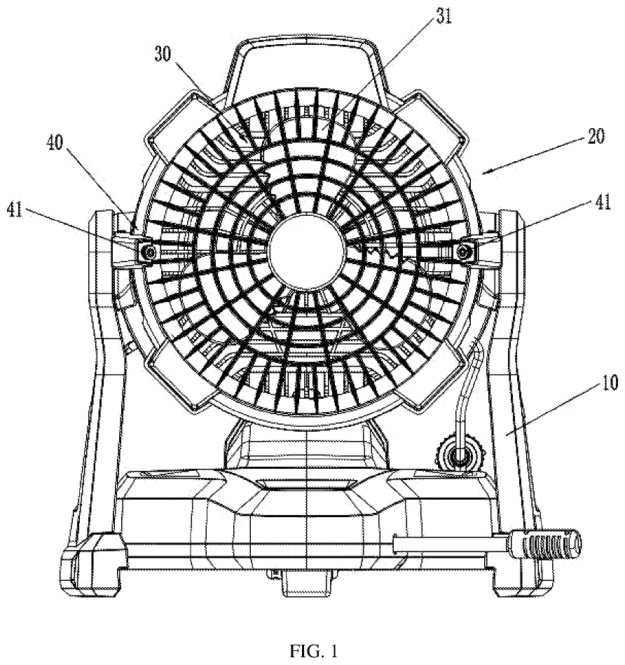

As shown in FIGS. 1 to 10, the present application provides a spray fan that implements blowing and spraying functions to blow out a wind with water mist and can cool and humidify a preset field. A water source of the spray fan includes a static water source (such as water in a bucket) and a dynamic water source (such as tap water).

Specifically, referring to FIG. 1, the spray fan includes a rack 10, a housing assembly 20, a fan assembly 30, and a spray head assembly 40. The housing assembly 20 is connected to the rack 10 and forms an accommodation space, and the fan assembly 30 is disposed in the accommodation space. The fan assembly 30 includes fan blades 31 and an electric motor, where the electric motor is configured to drive the fan blades 31 to rotate about an axis of the electric motor. The electric motor is sealed by a waterproof material, so as to prevent water mist from entering the electric motor under the action of an environment or the like. Specifically, the waterproof material may be, for example, a plastic film, and the electric motor is sealed by the plastic film through a process such as hot blast.

The spray head assembly 40 includes at least one jet 41, where the jet 41 is configured to spray water mist and mounted to the rack 10, the housing assembly 20, or the fan assembly 30. After the spray fan is started, the water mist is sprayed from the jet 41 into an ambient environment, and the fan blades 31 rotate to generate an air flow to blow the water mist sprayed from the jet 41 into the air, thereby reducing the temperature of the air in the environment. It is to be understood that the jet 41 is connected to a water pipe assembly, the water pipe assembly includes a water pump and a water outlet pipe, and the water outlet pipe connects the water pump to the jet 41. Water is drawn into the water outlet pipe under the action of the water pump and can be transported to the jet 41 in a high pressure state, so as to be sprayed in an atomized state. The water pump may be a vane pump such as a centrifugal pump, an axial-flow pump, or a mixed flow pump or may be a positive-displacement pump such as a piston pump, a diaphragm pump, or a gear pump.

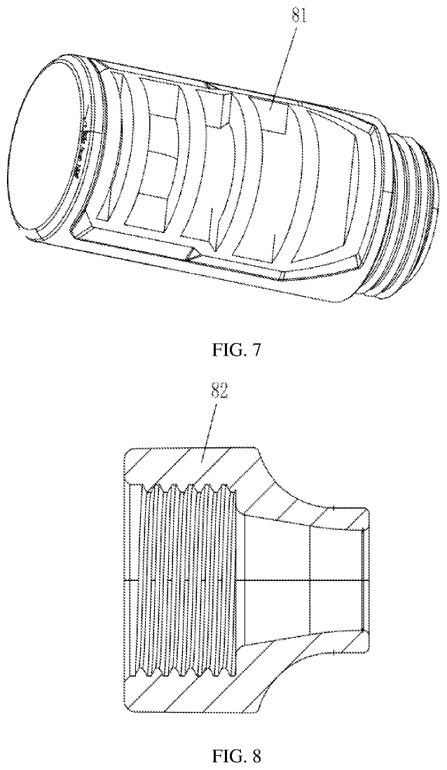

The spray fan further includes a water inlet pipe, where a rear end of the water inlet pipe is connected to the water pump through a pipeline, and a head end of the water inlet pipe extends outward from the spray fan and is connected to the water source. The water inlet pipe is connected to a first external water source or a second external water source by being mounted with different connectors. The first external water source is the static water source, and the second external water source is the dynamic water source. The static water source may be understood as water accommodated in a container, such as the water in the bucket. The dynamic water source may be understood as water having a certain flowrate, such as the tap water. The dynamic water source is generally accompanied with a water distribution pipe, such as a tap water pipe. The water distribution pipe is detachably connected to the water inlet pipe. A water pipe connector is provided on the water inlet pipe, where the water pipe connector includes a dynamic water pipe connector 82 and a static water pipe connector 81. Referring to FIG. 7, when the water inlet pipe is connected to the static water source, the static water pipe connector 81 is mounted to the water inlet pipe. Referring to FIG. 8, when the water inlet pipe is connected to the dynamic water source, the dynamic water pipe connector 82 is mounted to the water inlet pipe. Both the static water pipe connector 81 and the dynamic water pipe connector 82 are existing structures, and the details are not repeated here.

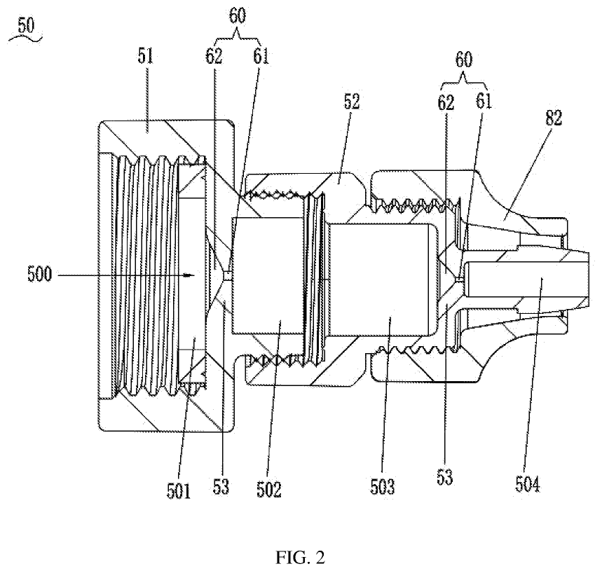

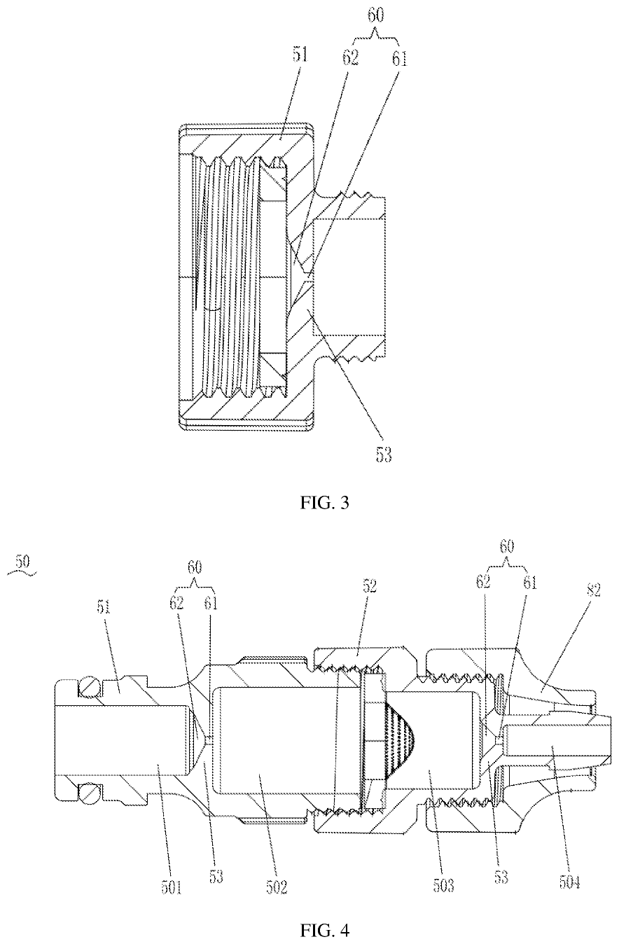

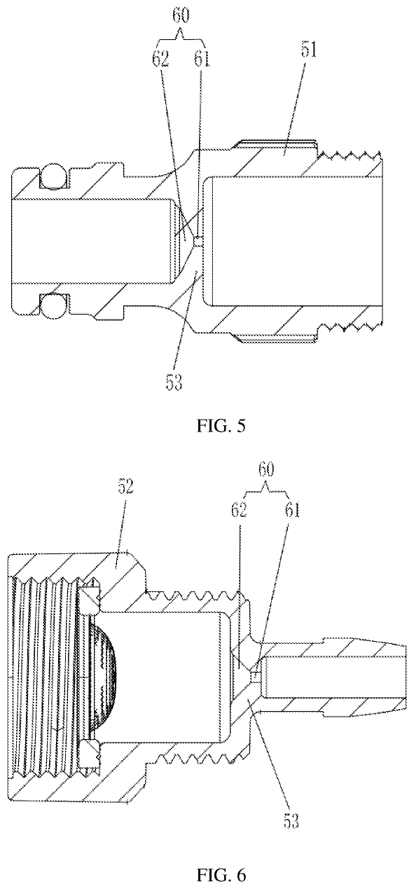

When the dynamic water source is connected, an adjustment device 50 is provided at a connection between the water inlet pipe and the water distribution pipe, where the adjustment device 50 is configured to adjust a flowrate of a liquid flowing in the spray fan. Referring to FIGS. 2 to 6, the adjustment device 50 includes a first connector 51 disposed at a rear end of the water distribution pipe and a second connector 52 disposed at the head end of the water inlet pipe. It is to be understood that the second connector 52 is connected to the dynamic water pipe connector 82 at the head end of the water inlet pipe. The first connector 51 and the second connector 52 are configured to be structures detachably connected to each other. Specifically, the connection may be implemented in a threaded manner or in a snap-fit or plug-in manner, which is not limited here. Referring to FIGS. 2 and 3, the first connector 51 may adopt an American standard male connector. Referring to FIGS. 4 and 5, the first connector 51 may also adopt a European standard male connector. Referring to FIG. 6, the second connector 52 is a female connector mating with the male connector.

The adjustment device includes a channel 500 for the liquid to flow through, and a flowrate and pressure of the liquid flowing through the channel 500 decrease and then increase. The adjustment device adjusts the flowrate and the pressure of the liquid, thereby reducing an effect of pressure of the water source on the water pump and extending a service life of the water pump. In this example, the adjustment device 50 is disposed upstream of the water pump. In other examples, the adjustment device 50 may be disposed downstream of the water pump.

With continued reference to FIGS. 2 to 6, the channel 500 is provided with an adjustment hole 60 whose cross-section changes such that the flowrate and the pressure of the liquid flowing through the channel 500 decrease and then increase. The flowrate and the pressure of the liquid can be controlled by the adjustment hole 60, so as to achieve speed regulation and pressure regulation. The ratio of the length to the diameter of the adjustment hole 60 is less than or equal to 0.5. In some examples, the ratio of the length to the diameter of the adjustment hole 60 is greater than 4. In some examples, the ratio of the length to the diameter of the adjustment hole 60 is greater than 0.5 and less than or equal to 4. When the liquid originally having a relatively large flowrate passes through the adjustment hole 60, the liquid is blocked at the adjustment hole 60. Since the liquid cannot change a direction suddenly, a pressure loss occurs in a process in which the liquid shrinks at the adjustment hole 60 and then diffuses after flowing out of the adjustment hole 60, and the flowrate of the liquid decreases after the liquid flows out of the adjustment hole 60. It is to be noted that the first connector 51 and the second connector 52 are each provided with a wall 53, the adjustment hole 60 is defined on the wall 53, and the wall thickness of the wall 53 is the length of the adjustment hole 60.

The jet 41 has a cross-section, and the liquid is sprayed from the jet 41 after passing through the cross-section of the jet 41. A total area of the cross-section of the at least one jet 41 is a sum of cross-sections of all jets 41. The ratio of the area of the cross-section of the adjustment hole 60 to the total area of the cross-section of the at least one jet 41 is greater than 1 and less than or equal to 45. In some examples, the ratio of the area of the cross-section of the adjustment hole 60 to the total area of the cross-section of the at least one jet 41 is greater than 1.1 and less than or equal to 20. In some examples, the ratio of the area of the cross-section of the adjustment hole 60 to the total area of the cross-section of the at least one jet 41 is greater than 1.2 and less than or equal to 10. In this example, the diameter of the adjustment hole 60 is greater than or equal to 0.1 mm and less than or equal to 6 mm. In some examples, the diameter of the adjustment hole 60 is greater than or equal to 0.4 mm and less than or equal to 3 mm. In some examples, the diameter of the adjustment hole 60 is greater than or equal to 0.6 mm and less than or equal to 1.2 mm.

In some examples, one adjustment hole 60 is provided. The channel 500 includes a first cavity 501 and a second cavity 502. The liquid has a first flowrate when flowing through the first cavity 501 and has a second flowrate when flowing through the second cavity 502. The first flowrate is basically the same as a flowrate of water in the tap water pipe. The ratio of the first flowrate to the second flowrate is greater than or equal to 14:1 and less than or equal to 30:1. The first flowrate is far greater than the second flowrate, and it can be seen that the dynamic water source has a greatly decreased water flowrate after passing through the adjustment hole 60. A flowrate of the liquid flowing through the adjustment hole 60 is greater than or equal to 3 L/min and less than or equal to 30 L/min. In some examples, the flowrate of the liquid flowing through the adjustment hole 60 is greater than or equal to 0.5 L/min and less than or equal to 25 L/min. In some examples, the flowrate of the liquid flowing through the adjustment hole 60 is greater than or equal to 0.6 L/min and less than or equal to 22 L/min.

In some other examples, two adjustment holes 60 are provided, and the liquid in the channel 500 flows through the two adjustment holes 60 in sequence. The flowrate of the liquid flowing through the channel 500 decreases and then increases and decreases and then increases for the second time. In addition to the first cavity 501 and the second cavity 502, the channel 500 further includes a third cavity 503 and a fourth cavity 504. The liquid has the first flowrate when flowing through the first cavity 501, has the second flowrate when flowing through the second cavity 502 and the third cavity 503, and has a third flowrate when flowing through the fourth cavity 504. The ratio of the first flowrate to the second flowrate is greater than or equal to 14:1 and less than or equal to 30:1. The ratio of the second flowrate to the third flowrate is greater than 1:1 and less than or equal to 7:3. The dynamic water source has a significantly decreased water flowrate after passing through the first adjustment hole 60 and a re-decreased water flowrate after passing through the second adjustment hole 60. The flowrate of the liquid is decreased twice when the liquid flows through the channel 500. The flowrate of the liquid gradually decreases, achieving a better throttling effect. Specifically, the first flowrate is greater than or equal to 20 L/min and less than or equal to 22 L/min, the second flowrate is greater than or equal to 0.9 L/min and less than or equal to 1.4 L/min, and the third flowrate is greater than or equal to 0.6 L/min and less than 0.9 L/min.

The adjustment hole 60 includes a guide portion 62 and a straight portion 61. The guide portion 62 is disposed at an upstream position of the adjustment hole 60. The guide portion 62 is funnel-shaped, and the straight portion 61 is cylindrical. The diameter of a tip of the guide portion 62 is equal to the diameter of the straight portion 61, and the tip of the guide portion 62 is connected to the straight portion 61. The guide portion 62 is located at the upstream position of the adjustment hole 60. When the liquid flows through the channel 500, the liquid flows through the guide portion 62 first and then flows through the straight portion 61 so that the flowrate of the liquid can be gradually decreased under the guidance of the guide portion 62 until the liquid flows to the straight portion 61, thereby improving smoothness of the liquid flowing to the straight portion 61. The guide portion 62 is funnel-shaped to facilitate machining and save a cost.

The preceding adjustment device is disposed so that water pressure at the output of the water pump is reduced to a value less than or equal to 1.2 Mpa. The water pressure at a water outlet of the water pump is small so that the water flow impacts on the water pump weakly, and the water pump is not easily damaged and has a long lifetime.

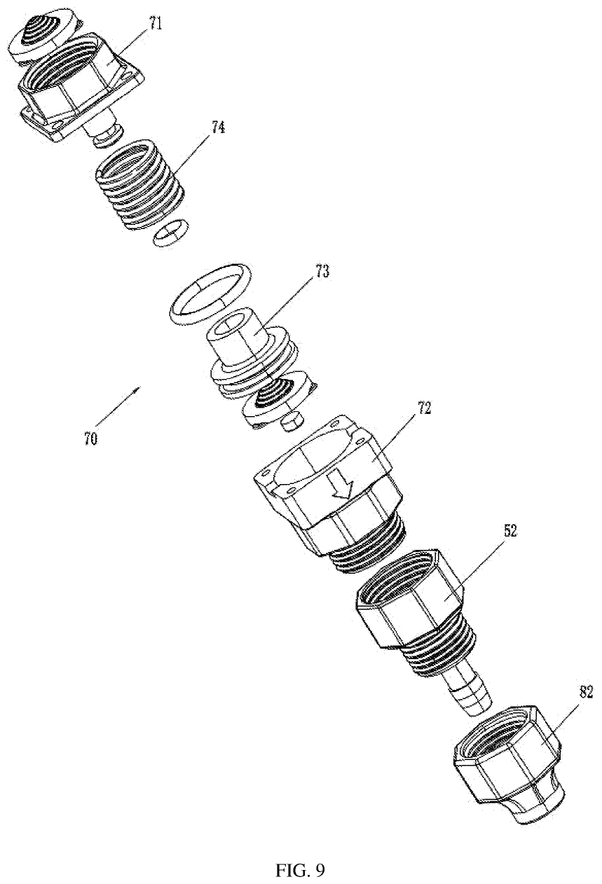

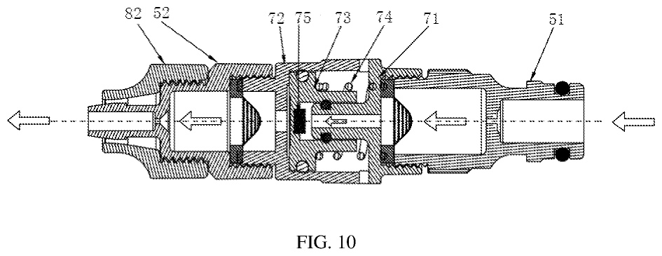

Referring to FIGS. 9 and 10, the spray fan further includes a relief valve 70 disposed upstream of the water pump, where the relief valve 70 has a piston 73, a spring 74 acts on the piston 73, and the spring 74 is configured to keep the piston 73 at a certain distance from a water inlet end of the relief valve 70. When backpressure at the water pump exceeds a set value, the piston 73 of the relief valve 70 retreats against the spring 74 so that a rubber plug 75 inside the piston 73 blocks the output of the water inlet end of the relief valve 70, so as to keep the pressure at the water pump at a stable pressure value. When the pressure at the water pump decreases, the spring 74 pushes the piston 73 forward to reset the piston 73, and the external water source passes through the relief valve 70 and enters the water pump at the rear end. The preceding action principle is repeated so that the water pump is kept in a zero-pressure state during normal operation.

In some examples, the relief valve 70 may be disposed between the first connector 51 and the second connector 52, and a valve body 71 at the water inlet end of the relief valve 70 is detachably connected to the first connector 51, where the connection may be implemented in the threaded manner or in the snap-fit or plug-in manner, which is not limited here; and a valve body 72 at a water outlet end of the relief valve 70 is detachably connected to the second connector 52, where the connection may also be implemented in the threaded manner or in the snap-fit or plug-in manner, which is not limited here. Of course, the position of the relief valve 70 is not limited to this so long as it is ensured that the relief valve 70 is disposed upstream of the water pump.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A spray fan, comprising:
a fan assembly comprising a plurality of fan blades;
an electric motor for driving the fan blades to rotate;
a spray head assembly configured to spray a liquid;
a water pump configured to deliver the liquid; and
an adjustment device comprising a channel for the liquid to flow through, wherein the adjustment device is configured to adjust a flowrate of the liquid by decreasing and then increasing the flowrate of the liquid flowing through the channel.

2. The spray fan according to claim 1, wherein the channel is provided with an adjustment hole whose cross-section changes such that the flowrate of the liquid flowing through the channel decreases and then increases.

3. The spray fan according to claim 2, wherein a diameter of the adjustment hole is greater than or equal to 0.1 mm and less than or equal to 6 mm.

4. The spray fan according to claim 2, wherein the spray head assembly comprises at least one jet, and a ratio of an area of the cross-section of the adjustment hole to a total area of a cross-section of the at least one jet is greater than 1 and less than or equal to 45.

5. The spray fan according to claim 2, wherein a flowrate of the liquid flowing through the adjustment hole is greater than or equal to 3 L/min and less than or equal to 30 L/min.

6. The spray fan according to claim 2, wherein two adjustment holes are provided, and the liquid in the channel flows through the two adjustment holes in sequence.

7. The spray fan according to claim 1, wherein the adjustment device is further configured to adjust the flowrate of the liquid flowing through the channel by decreasing and then increasing the flowrate of the liquid flowing through the channel a second time.

8. The spray fan according to claim 7, wherein the liquid flowing through the channel has a first flowrate, a second flowrate, and a third flowrate, wherein the first flowrate is greater than or equal to 20 L/min and less than or equal to 22 L/min, the second flowrate is greater than or equal to 0.9 L/min and less than or equal to 1.4 L/min, and the third flowrate is greater than or equal to 0.6 L/min and less than 0.9 L/min.

9. The spray fan according to claim 7, wherein the liquid flowing through the channel has a first flowrate, a second flowrate, and a third flowrate, wherein a ratio of the first flowrate to the second flowrate is greater than or equal to 14:1 and less than or equal to 30:1, and a ratio of the second flowrate to the third flowrate is greater than 1:1 and less than or equal to 7:3.

10. The spray fan according to claim 2, wherein the spray fan comprises a water inlet pipe, the adjustment device comprises a first connector and a second connector, the first connector is connected to a water distribution pipe, the second connector is connected to the water inlet pipe, the first connector and the second connector are detachably connected, and the first connector and/or the second connector are provided with the adjustment hole.

11. The spray fan according to claim 1, wherein water pressure at an output of the water pump is less than or equal to 1.2 Mpa.

12. The spray fan according to claim 1, wherein the spray fan comprises a water inlet pipe with an end connected to a dynamic water source or a static water source and another end connected to the water pump, the adjustment device is disposed at an end of the water inlet pipe facing away from the water pump, and the liquid flows from the dynamic water source or the static water source to the water pump through the water inlet pipe and then sprayed out from the spray head assembly.

13. The spray fan according to claim 2, wherein a ratio of a length to a diameter of the adjustment hole is less than or equal to 0.5.

14. The spray fan according to claim 2, wherein the adjustment hole comprises a straight portion and a funnel-shaped guide portion, and the guide portion is located at an upstream position of the adjustment hole relative to the straight portion.

15. The spray fan according to claim 1, further comprising a relief valve disposed upstream of the water pump.

16. A spray fan, comprising:
a fan assembly comprising a plurality of fan blades;
an electric motor for driving the fan blades to rotate;
a spray head assembly configured to spray a liquid;
a water pump configured to deliver the liquid; and
an adjustment device comprising a channel for the liquid to flow through, wherein the adjustment device is configured to adjust a flowrate of the liquid by decreasing and then increasing a pressure of the liquid flowing through the channel.

17. The spray fan according to claim 16, wherein the channel is provided with an adjustment hole whose cross-section changes such that the pressure of the liquid flowing through the channel decreases and then increases.

18. A spray fan, comprising:
a fan assembly comprising a plurality of fan blades;
an electric motor for driving the fan blades to rotate;
a spray head assembly configured to spray a liquid;
a water pump configured to deliver the liquid; and
an adjustment device comprising a channel for the liquid to flow through, wherein the adjustment device is configured to adjust a flowrate of the liquid flowing through the channel whereby the liquid flowing through the channel has a first flowrate and a second flowrate, and a ratio of the first flowrate to the second flowrate is greater than or equal to 14:1 and less than or equal to 30:1.

19. The spray fan according to claim 18, wherein the channel is provided with an adjustment hole whose cross-section changes such that a flowrate of the liquid flowing through the channel decreases and then increases.

20. The spray fan according to claim 19, wherein a diameter of the adjustment hole is greater than or equal to 0.1 mm and less than or equal to 6 mm.
